(19) United States
(12) Patent Application Publication
(10) Pub. No.: US 2014/0244328 A1
(43) Pub. Date: Aug. 28, 2014

(54) WIND TURBINE MAINTENANCE OPTIMIZER

(71) Applicant: VESTAS WIND SYSTEMS A/S, Aarhus N (DK)

(72) Inventors: Yu ZHOU, Singapore (SG); Mohamed Faisal Bin MOHAMED SALLEH, Singapore (SG); Lars Rath PEDERSEN, Fieldsings (NZ)

(73) Assignee: VESTAS WIND SYSTEMS A/S, Aarhus N (DK)

(21) Appl. No.: 14/186,854

(22) Filed: Feb. 21, 2014

Related U.S. Application Data
(60) Provisional application No. 61/768,360, filed on Feb. 22, 2013.

(51) Int. Cl. G06Q 10/00; G06Q 10/06

(52) U.S. Cl. CPC G06Q 10/20; G06Q 10/06311
USPC 705/7.13

(57) ABSTRACT

A service planning engine may predict the future wind speed at a wind farm as well as the future price of energy of the utility grid coupled to the wind turbines. Based on the predicted values, the service planning engine identifies times to perform maintenance when lost revenue is minimized—e.g., when the predicted price of energy is low. Furthermore, the service planning engine may calculate a service priority associated with the turbine to determine when to perform service. The service priority may be based on a status signal associated with the component to be serviced or the time window stipulated in the service contract for performing the maintenance. In one embodiment, the service planning engine also considers resource constraints such as labor costs (e.g., work schedules, overtime costs, availability of technicians with certain skills, availability of components, shipping costs, and the like).

### CROSS-REFERENCE TO RELATED APPLICATIONS

This application is a non-provisional of provisional application 61/768,360, filed Feb. 22, 2013. The aforementioned related patent application is herein incorporated by reference in its entirety.

### BACKGROUND

1. Field of the Invention

Embodiments of the invention generally relate to performing maintenance on wind turbines and, more particularly, to considering revenue when scheduling preventative maintenance tasks.

2. Description of the Related Art

Wind turbines are often situated in remote areas to take advantage of prevalent weather patterns in the area. In these remote areas, the wind turbines are often exposed to extreme environmental conditions such as extreme temperatures, rain, snow, ice, blowing debris, and rough seas. These harsh conditions may cause premature failure of components in a turbine. In addition, inspection and maintenance of the wind turbines is much more difficult and often more expensive to complete. Accordingly, performing preventive maintenance to avoid component failure may be a cost-effective technique for maximizing the revenue produced by a wind turbine by preventing or minimizing power disruption associated with the component failure.

### SUMMARY

One embodiment of the present disclosure is a method, a system, and a computer program product for scheduling a maintenance task in a power plant. The method, system, and computer program product include generating, based on one or more processors, a predicted cost of electrical power associated with a utility grid coupled to the power plant for a time window. The method, system, and computer program product include identifying a time slot within the time window for performing the maintenance task. Upon determining that the predicted cost during the identified time slot is expected to be below a cost threshold, the method, system, and computer program product schedule the maintenance task in a maintenance schedule. Upon determining that the predicted cost during the identified time slot is expected to be above the cost threshold, the method, system, and computer program product determine whether the maintenance task can be postponed based on a service deadline associated with the maintenance task.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates a diagrammatic view of a wind turbine generator, according to one embodiment described herein.

FIG. 2 illustrates a service planning system, according to one embodiment described herein.

FIGS. 3A-3B illustrate an energy price forecasting technique, according to embodiments described herein.

FIGS. 4A-4B illustrate a method of scheduling service tasks, according to embodiments described herein.

FIG. 5 illustrates an incentive graph based wind speed and energy cost, according to one embodiment described herein.

FIG. 6 illustrates a method of evaluating the probability that a component will fail, according to one embodiment described herein.

FIG. 7 illustrates a computing system for generating a maintenance schedule, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Determining when to perform preventative maintenance is an important consideration for maximizing the revenue of a wind turbine. Preventative maintenance may be scheduled to minimize the cost of repair and the lost power production. For example, the owner of the wind farm may sign a service contract that specifies a particular schedule or window for performing service on the components in the wind turbines. However, performing maintenance on certain components in a wind turbine may require disconnecting the turbine from the grid (i.e., taking the turbine offline), thereby reducing the amount of revenue produced by the farm. Because the revenue generated by the wind farm is dependent on both the wind speed and the energy price (i.e., the cost of a unit of energy), a service planning engine may generate an incentive table to aid in scheduling maintenance tasks. Specifically, the incentive table enables the service planning engine to perform maintenance such that the lost revenue is minimized.

To generate the incentive tables and schedule the maintenance tasks, the service planning engine may predict the future wind speed at the wind farm as well as the future price of energy of the utility grid coupled to the wind turbines. Based on the predicted values, the service planning engine identifies times to perform maintenance when lost revenue is minimized. Furthermore, the service planning engine may calculate a service priority associated with the turbine to determine when to perform service. The service priority may be based on a status signal associated with the component to be serviced or the time window stipulated in the service contract for performing the maintenance. In one embodiment, the service planning engine also considers resource constraints such as labor costs (e.g., work schedules, overtime costs, availability of technicians with certain skills, availability of components, shipping costs, and the like).

Embodiments of the present invention will now be explained in further details. While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

### An Example Wind Turbine Generator

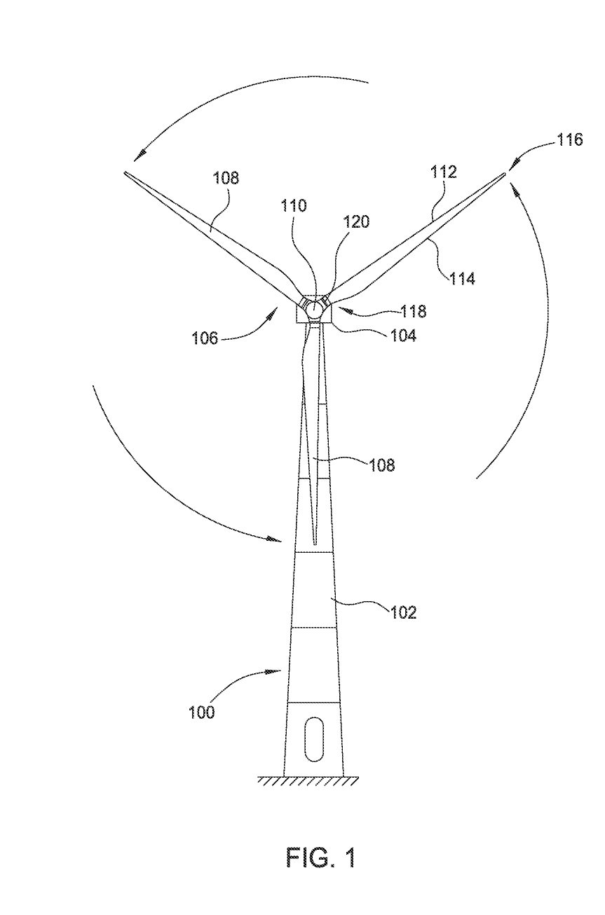

FIG. 1 illustrates a diagrammatic view of a horizontal-axis wind turbine generator 100. The wind turbine generator 100 typically includes a tower 102 and a wind turbine nacelle 104 located at the top of the tower 102. A wind turbine rotor 106 may be connected with the nacelle 104 through a low speed shaft extending out of the nacelle 104. The wind turbine rotor 106 includes three rotor blades 108 mounted on a common hub 110, but may include any suitable number of blades, such as one, two, four, five, or more blades. The blade 108 (or airfoil) typically has an aerodynamic shape with a leading edge 112 for facing into the wind, a trailing edge 114 at the opposite end of a chord for the blade 108, a tip 116, and a root 118 for attaching to the hub 110 in any suitable manner.

For some embodiments, the blades 108 may be connected to the hub 110 using pitch bearings 120 such that each blade 108 may be rotated around its longitudinal axis to adjust the blade's pitch. The pitch angle of a blade 108 may be controlled by linear actuators or stepper motors, for example, connected between the hub 110 and the blade 108.

### Scheduling Maintenance Tasks

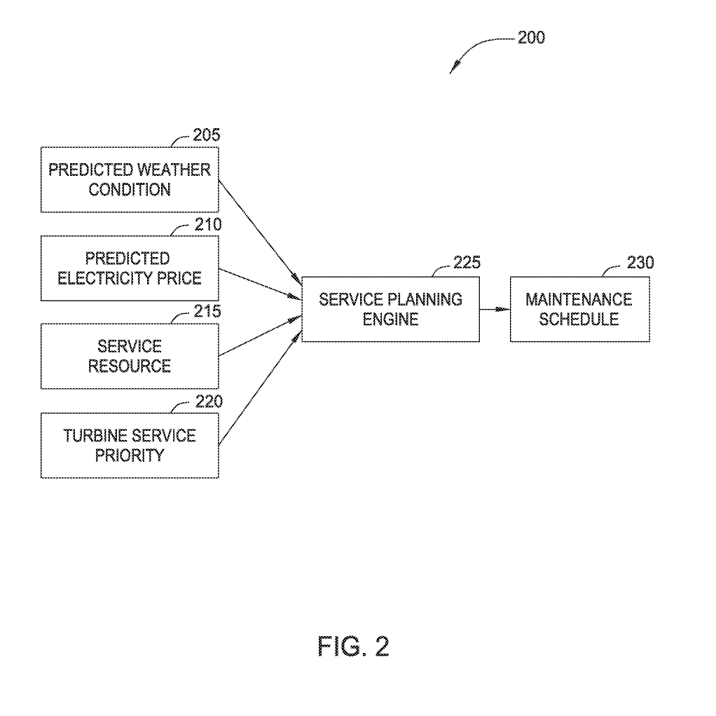

FIG. 2 illustrates a service planning system 200, according to one embodiment described herein. The service planning system 200 includes a service planning engine 225 that receives as inputs a predicted weather condition 205, a predicted electricity price 210, available service resources 215, and a turbine service priority 220. Based on these values, the service planning engine 225 outputs a maintenance schedule 230 for one or more components in a turbine (or multiple turbines in a wind farm or park). For example, the service planning engine 225 may be tasked with generating a maintenance schedule for the components in a single turbine or the components in multiple turbines.

The predicted weather condition 205 may be a predicted wind speed for a given time horizon (e.g., a user-specified future time period). Generally, lower wind speeds reduce the maximum amount of power a wind turbine can produce while high wind speeds increase the maximum amount of power a turbine can generate. However, wind turbines are rated for different maximum wind speeds. As wind speeds increase, the wind turbines may pitch the blades to allow more of the wind to pass through the rotor plane or apply a rotor brake to control the rotor speed. Furthermore, the wind speed may make service on the wind turbine unsafe. For example, some service activities require a technician to use a crane to perform the maintenance. The crane may tip over in certain wind conditions (e.g., greater than 20 m/s). Accordingly, the service planning engine 225 may use the predicted weather condition 205 for two purposes. One, the engine 225 may not schedule service tasks that may be unsafe in windy conditions when the predicted weather condition 205 forecasts that the wind conditions will make the maintenance tasks unsafe. Second, the engine 225 may use the predicted weather condition 205 to identify a time period where the forecasted wind speed is not ideal for generating power. Doing the latter may reduce the revenue lost when the turbine is disconnected from the grid during maintenance activities. In one embodiment, the predicted weather condition 205 is used in conjunction with an incentive graph which will be discussed later.

In one embodiment, the predicted weather condition 205 may include other weather conditions besides the forecasted wind speed. Generally, the service planning engine 225 may consider any weather condition that affects the ability of a turbine to generate power or would make service unsafe. For example, icing conditions could reduce the power generated by the turbine, and thus, be an acceptable time for performing service (assuming the conditions are safe for performing the maintenance).

The predicted electricity price 210 is a forecast of the energy price (cost/megawatt hour) for a given time horizon (e.g., the same time period associated with the predicted weather condition 205). The predicted electricity price 210 may depend on a plurality of different factors such as the historical price, historical load or demand, seasonal effect, temperature, and the like. An electricity price algorithm may use these factors to then predict the electricity price 210. A more detailed explanation of predicted the electricity price will be discussed later.

The service resources 215 include labor resources—e.g., cost of labor, availability of labor, overtime costs, specialties of the technicians, and the like—and inventory limitations—e.g., availability of replacement parts, cost of parts, current inventory, transit time for shipping replacements, and the like. For example, if performing maintenance on a component would require paying a technician overtime or paying extra for rush delivery of a part, these costs may be considered when determining if the maintenance schedule maximizes revenue. Moreover, if a part is unavailable, this may limit when the service planning engine 225 can schedule the maintenance task. That is, the maintenance task may have to wait until the required part is shipped to the wind farm.

The turbine service priority 220 aids the service planning engine to determine a priority between turbines (or between components). For example, the service planning engine 225 may schedule a maintenance task associated with a component with a higher service priority before a component with a lower service priority. In one embodiment, the service priority of a particular component is based on a status signal (e.g., an alert) associated with the component. For example, the status signal may indicate the temperature of the component, e.g., a green signal indicating that the temperature is optimal, an orange signal indicating the temperature is above the optimal temperature, and a red signal indicating that the temperature could cause damage to the component. A component with a red signal may be assigned a higher service priority than a component with a green or orange signal. Moreover, the service priority enables the service planning engine 225 to compare different types of components. That is, a generator may be assigned a service priority (e.g., a numerical score from 1-100) based on the vibration near the generator while a gearbox is assigned a service priority (e.g., a numerical score from 1-100) based on the temperature of the lubrication in the gearbox. Because the service priorities use the same numerical range, the service planning engine 225 is able to determine an order of the maintenance task even though the service priorities are assigned based on different underlying metrics. Additionally, the service priority may change based on the duration the status signal remains at a particular level (e.g., how long the status signal is red) or the number of times within a defined period of time the status signal indicates an alert (e.g., the vibration exceeds a threshold five times in a two-minute period).

In another embodiment, the service priority is based on a time window stipulated in the service contract for performing the maintenance. For example, the service contract may dictate that the generator should be serviced once a year or that a turbine blade should be inspected twice a year. Accordingly, the service planning engine has a year-long window for scheduling maintenance on the generator but only half a year for scheduling service on the blade. At the beginning of the service window, the service priority may be low, but as the end of the window approaches the service priority may ramp up (either linearly or non-linearly) to a maximum value. In this manner, the service planning engine 225 may evaluate each service request using the associated service priority to ensure the requirements in the service contract are satisfied. In other embodiments, the service priority may also be generated based on a combination of the factors discussed above.

The service planning engine 225 uses the different inputs to generate a maintenance schedule 230. Specifically, the service planning engine 225 balances between the different requirements for performing maintenance, such as the demands of the service contract, current status of the components, labor availability, availability of replacement parts, the predicted weather conditions, and the predicted electricity price to determine a maintenance schedule 230 that maximizes the revenue of the wind turbine. Generally, so long as the requirements are satisfied, the service planning engine 225 attempts to schedule the maintenance tasks when weather conditions 205 will be best for providing service and the predicted electricity price 210 will be low. The details of making this selection will be discussed in greater detail below.

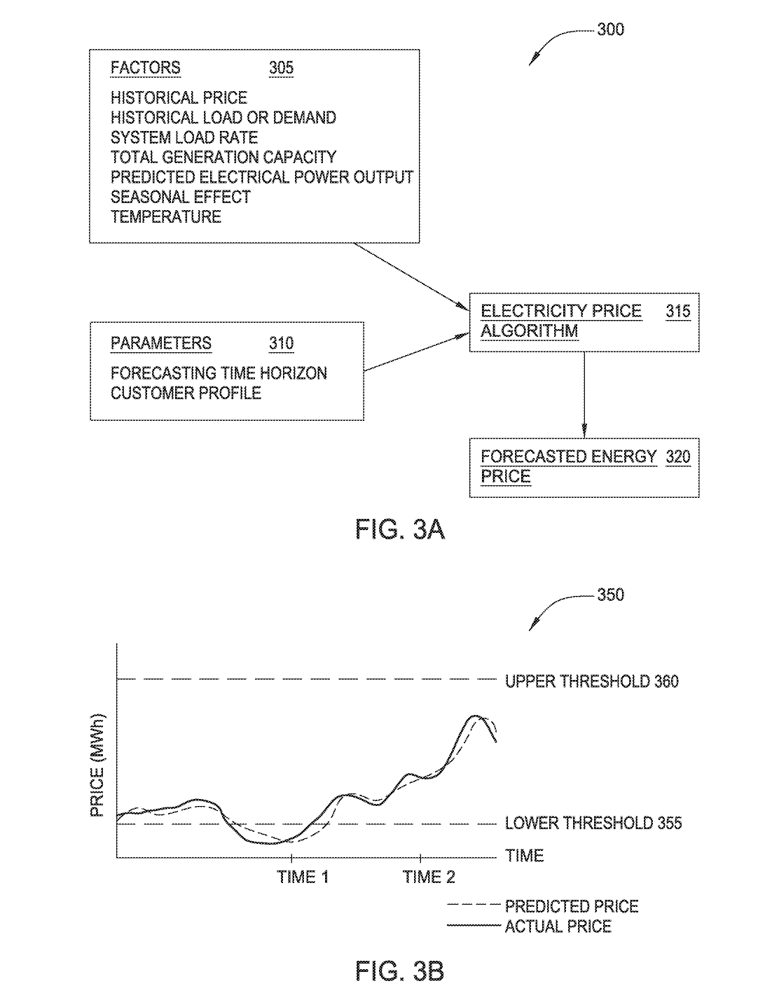

FIGS. 3A-3B illustrate an energy price forecasting technique, according to embodiments described herein. The system 300 of FIG. 3A considers one or more pricing factors 305 and parameters 310 for predicting the price of energy (e.g., price per megawatt) at a future date. Example factors 305 include the historical price of energy, historical load or demand, system load rate, the total possible generation capacity of all the different energy power plants attached to the grid, predicted electrical generation of the different energy power plants attached to the grid, seasonal effects of weather, and temperature (current or predicted). In one embodiment, energy price may be predicted based on simply supply and demand models. Some of the factors 305 may be used to calculate the supply while others are used to calculate the demand. To estimate the total supply, an electricity price prediction module (a software application) may consider the predicted electrical generation of the different power plants or the total generation capacity of the power plants coupled to the utility grid. For some power plants, e.g., coal or nuclear power, the electrical generation may be relatively stable while other power plants, e.g., hydroelectricity, may vary based on environmental conditions. That is, a dam may produce less electricity during a drought when water levels are low. Moreover, the total generation capacity may change as new power plants are connected to the same grid as the wind farm.

Other factors 305, such as historical demand or loading, system load rate, and the weather, may be used to predict demand. For example, the extreme temperatures in summer and winter may cause demand to increase relative to the milder temperatures in spring and fall. Furthermore, the rate at which new loads (e.g., new residential neighborhoods) are being added to the utility grid may also indicate how demand may change in the future. Moreover, the historical price may also be used to further refine the predicted supply or demand. Of course, the electricity price prediction module may consider more or less than these factors when predicting a future price of energy.

The electricity price prediction module may also receive as an input the parameters 310 which include a forecasting time horizon and a customer profile. The time horizon may provide the electricity price prediction module with a time frame to predict the future energy price—e.g., calculate the future price for the next sixty days. The customer profile may customize the energy price to correspond to the needs of the customer (i.e., the wind farm owner).

The factors 305 and parameters 310 may be inputs into an electricity price forecasting algorithm 315 of the electricity price prediction module. In one embodiment, the algorithm 315 uses a fuzzy neural network method to predict the forecasted energy price 320 based on the factors 305 and the parameters 310. In other embodiments, the algorithm 315 may generate supply and demand curves based on the factors and estimate the forecasted energy price 320 based on those curves. However, the energy price algorithm 315 is not limited to any particular type of forecasting model or technique. Regardless of the technique used, the system 300 may transmit these prices to an output interface which may display the forecasted energy prices 320 or transmit the prices directly to the service planning engine for further processing.

FIG. 3B is a graph 350 that includes the predicted price generated by the electricity price prediction module for a particular time horizon. The graph 350 also includes the actual price that is measured during the same period. For example, the electricity price prediction module may predict the price of electricity and then measure the actual price to determine the accuracy of its prediction. In one embodiment, the graph 350 may include one or more ranges. As shown, the graph 350 includes a lower threshold 355 and an upper threshold 360. One range may include the electricity prices below the lower threshold 355, a second range may be the electricity prices between the upper and lower thresholds 355 and 360, a third range may be the electricity prices above the upper threshold 360.

By comparing the predicted price curve to the actual price curve, the electricity price prediction module may determine an accuracy score associated with the predicted prices within the three ranges. For example, the electricity price prediction module may determine that the predicted price is 90% accurate at predicting whether the energy price will be below the lower threshold 355 (i.e., the first range), 85% accurate at predicting energy prices between the thresholds 355 and 360 (i.e., the second range), and 93% accurate when predicting energy prices above the upper threshold 360 (i.e., the third range). This accuracy score may then be used by the service planning engine to schedule service tasks. For example, if the accuracy score for the first range is above a predefined threshold (e.g., above 90%), the service planning engine may schedule maintenance tasks to occur when the electricity price prediction module predicts that the electricity price will be below the lower threshold 355.

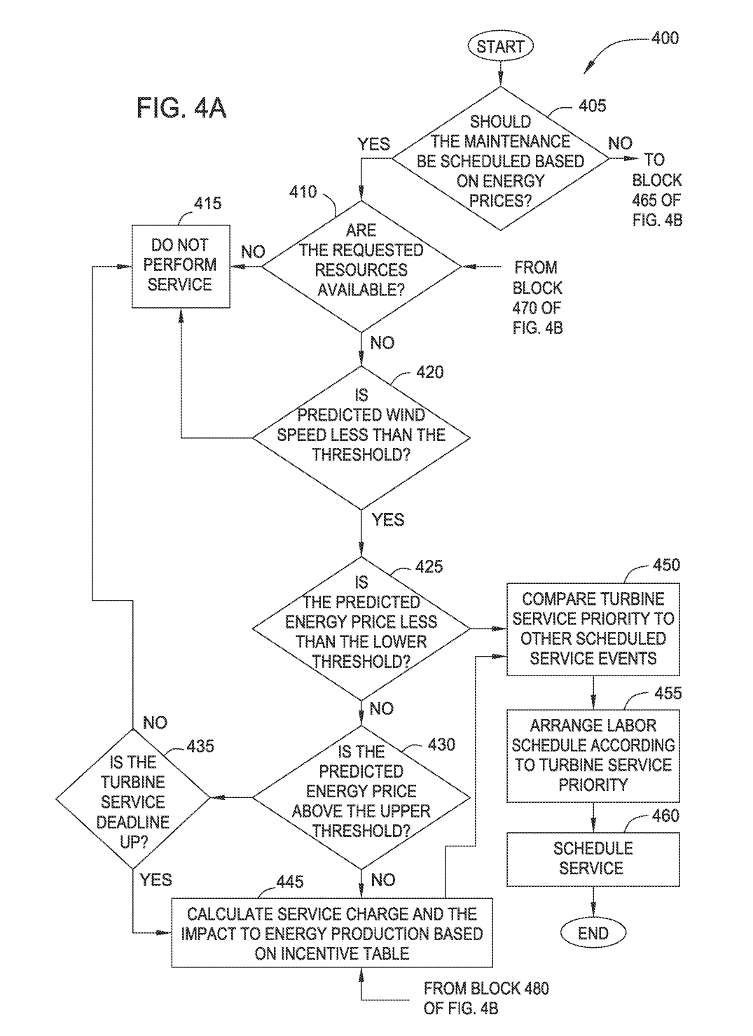

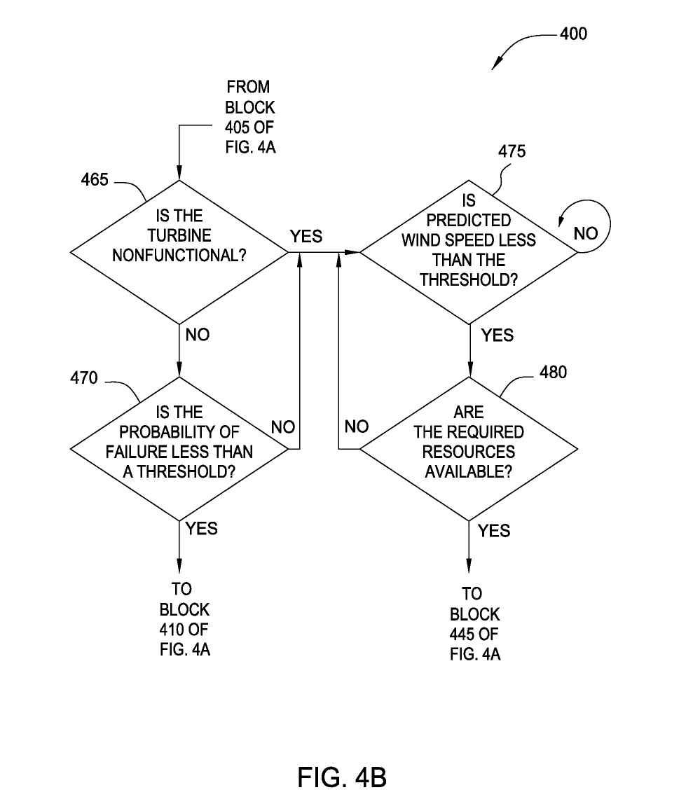

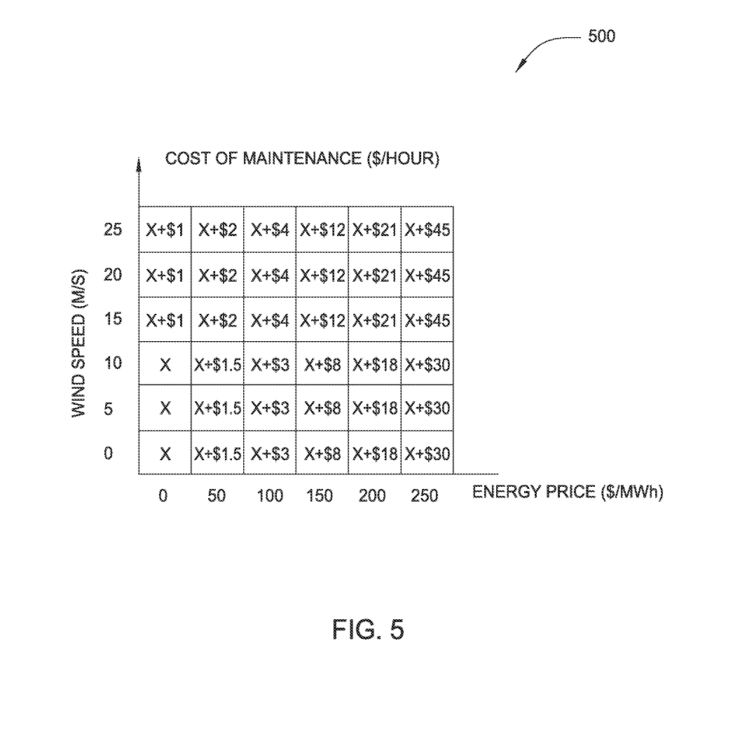

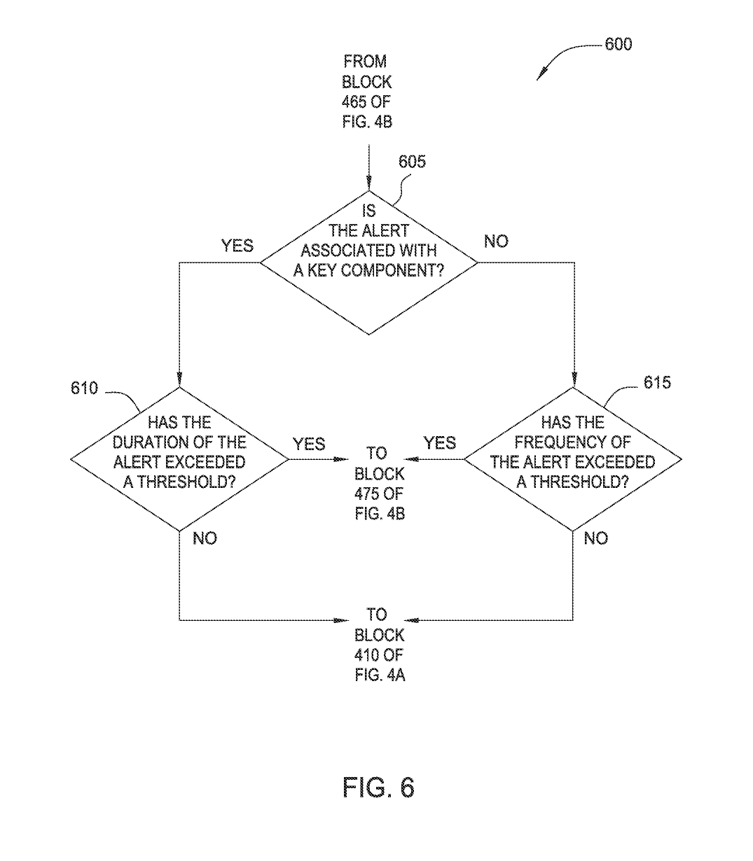

FIGS. 4A-4B illustrate a method 400 of scheduling service tasks, according to embodiments described herein. The 400 begins at block 405 where the service planning engine determines whether to perform an optimized service task or a non-optimized service task on a component in a wind turbine. As used herein, an optimized service task may include one or more maintenance tasks that are scheduled to minimize the lost revenue. A non-optimized service task may include one or more maintenance task that may need immediate attention. For example, the non-optimized service task may still take place in the future, but may not be scheduled in a time slot that minimizes lost revenue. Instead, when instructing a technician to perform non-optimized service task, the price of electricity or the power production of the wind turbine may not be a factor. Generally, the method 400 is divided into two portions. The first portion explains a technique for generating an optimized service (FIG. 4A) while the second portion (FIG. 4B) explains a technique for generating non-optimized service task.

To determine whether to perform optimized or non-optimized service tasks, the service planning engine may evaluate a plurality of signals provided by the turbine. The turbine may, for example, include a monitoring system that outputs a plurality of signals associated with the different components or systems in the turbine. The signals may be status signals or alerts associated with the components that the service planning engine may use to generate a severity level. So long as the severity level remains below a threshold, the service planning engine may generate a schedule service task (i.e., proceed to block 410) for performing maintenance on the component rather than planning an urgent or emergency non-optimized service task. For example, a generator may be scheduled for service sometime next month, however, the service planning engine may determine that the optimized service should be replaced by a non-optimized, emergency service task based on an updated status signal. The service planning engine may determine the severity level based on the type of alerts associated with a component (e.g., green, orange, or red), the duration of those alerts, or the number of alerts within a defined period of time.

Assuming the severity level is below a predefined threshold, at block 410, the service planning engine determines if the required resources for performing the service tasks are available. The required resources include labor resources such as technician availability, available time slots, inventory, and the like. For example, a technician may be scheduled to go to a particular wind park at certain intervals (e.g., every other Tuesday) to perform maintenance on turbines in the park while specialized technicians may go to a park less frequently (e.g., every three months). If the service planning engine schedules maintenance tasks only within a certain window (e.g., up to a month in advance) but the task requires the specialized technician, the engine may have to wait until the specialized technician is scheduled to visit the wind park within the window. Moreover, the part for performing the service may not be currently available to the technician. Accordingly, the service planning engine may proceed to block 415 and not perform the service because of either labor or material constraints. The service planning engine may reevaluate the component at a future time—e.g., next month—to determine if the required resources are now available.

If the resources are available, at block 420, the service planning engine determines whether a maintenance task may be scheduled based on the predicted weather conditions. The service planning engine may have only a limited number of time slots during which service can be performed—e.g., when a technician visits the wind park. At block 420, the service planning engine evaluates each time slot and determines whether the weather conditions permit the service to be schedule. For example, performing an inspection on the blades may require a bucket truck for lifting a technician to the blades. However, operation of the bucket truck in certain weather conditions (e.g., wind speeds above 20 m/s) may result in unsafe working conditions. Accordingly, if all the available time slots occur when weather conditions are expected to make the maintenance activity unsafe, the method 400 proceeds to block 415 where the maintenance task is not scheduled. The service planning engine may reevaluate the component at a future time—e.g., when the service planning engine receives updated predicted weather conditions—to determine if maintenance task can be performed.

In one embodiment, block 420 may be omitted from the method 400. For example, some component service may not be dependent on weather conditions for the service tasks to be completed safely (e.g., service tasks that do not require a technician to be outside in the wind). For those tasks, the service planning engine may skip to block 425.

At block 425, the service planning engine determines if one of the available time slots has a predicted energy price less than the lower threshold 355 shown in FIG. 3B. For example, if one of the available time slots occurs during Time 1 of FIG. 3B, the service planning engine proceeds to block 450 to schedule the maintenance. If none of the time slots are below the lower threshold, however, the method 400 proceeds to block 430. The lower threshold may be chosen such that the lost revenue from performing maintenance is no longer a factor (i.e., the lost revenue can be ignored). For example, if the energy price is below $45/MWh, any lost revenue will be minimal and this factor can be ignored. Thus, performing maintenance at a time when the energy price is below the lower threshold minimizes the lost revenue. In one embodiment, the lower threshold may be set by the wind turbine owner and defined in the service contract.

In addition to comparing the predicted energy price with the lower threshold, in one embodiment, the service planning engine may evaluate the accuracy score associated with the range of predicted energy price. As discussed above, the accuracy score reflects the likelihood that the energy prediction module correctly predicts that the price is within a certain range (e.g., from the lower threshold 355 to zero). Because the accuracy score may vary—i.e., the factors used by the energy prediction module may more accurately forecast the energy price at some time periods relative to others—the service planning engine may compare the current accuracy score to a predefined threshold. That is, the energy prediction module may constantly compare its predicted price with the actual price and update the accuracies scores for the ranges to mitigate the risk of scheduling maintenance when the turbine revenues may be outside of the predicted range. If the accuracy score for the range of energy prices below the lower threshold exceeds the threshold, the method 400 proceeds to block 450. If it does not, the method 450 proceeds to 430.

At block 430, the service planning engine determines whether the predicted energy price for the available time slots is above the upper threshold 360 shown in FIG. 3B. For example, a wind turbine owner may not want maintenance performed (i.e., turbines taken offline) when the power produced by the wind turbines can be sold at the higher energy prices. If all the available time slots are above the upper threshold, the method 400 proceeds to block 435 to see if the maintenance can be postponed. If, however, there is an available time slot where the predicted price is below the upper threshold, the method 400 proceeds to block 445. Thus, if the method 400 proceeds to block 445, the service planning engine has identified at least one time slot where the predicted energy price is likely to be above the lower threshold 355 but below the upper threshold 360.

In one embodiment, the service planning engine may also use an accuracy score associated with the range of energy prices that are above the upper threshold. Even if the predicted energy price is above the upper threshold, the service planning engine may determine whether the current accuracy score of the upper range exceeds a predefined threshold. If so, the method 400 proceeds to block 435 to attempt to postpone the maintenance, but if not, the method 400 proceeds to block 445.

At block 435, the service planning engine may evaluate the remaining window for performing the maintenance using the time periods defined in the service contract. That is, even if the energy prices exceed the upper threshold in the available time slots, the service planning engine may nonetheless schedule the service to satisfy the demands of the service contract. For example, if the contract stipulates that the generator must be serviced at least once a year and this is the last time the technician will visit the wind park before a year since the last service has transpired, the method proceeds to step 445 to schedule the service. However, if the service can be postponed (i.e., until predicted energy prices for a new time window are received), the method proceeds to block 415 and the service planning engine does not schedule the maintenance tasks associated with the particular component.

At block 445, the service planning engine may calculate the service charge and the impact to energy production based on an incentive table. FIG. 5 illustrates an incentive table 500 based wind speed and energy cost, according to one embodiment described herein. The X axis of the table 500 illustrates the energy price that a unit of energy (MWh) can be sold for in the utility grid coupled to the wind turbine. The Y axis is the current wind speed. The value at each intersection is the cost of performing maintenance for a particular wind speed and energy price (i.e., “X” is the base price that is then adjusted as the wind speed and/or the energy price increase). The cost of performing maintenance may vary based on two factors: the costs incurred by the service provider (labor, parts, etc.) and the costs incurred by the wind turbine owner from lost revenue because a turbine is offline. As shown by the table 500, it may be more expensive to a service provider to perform service activities in higher wind speeds. Moreover, cost of maintenance generally increases as both the wind speed increases and the energy price increase. For example, as the wind speed increases the maximum amount of power a turbine can generate also increases, thereby increasing the lost revenue suffered by the wind turbine owner if the turbine is offline for maintenance. The cost of maintenance may also increase as the energy price increases because the opportunity costs of selling the power instead of performing maintenance increases. In one embodiment, the service provider may use the incentive graph to determine how much to charge the customer (i.e., the wind turbine owner).

The incentive table 500 may be used to determine when to perform maintenance. For example, if the predicted price for the next several days is the same but the predicted wind speed will change from, e.g., 15 m/s to 10 m/s, the turbine inspection date may be changed such that the service charge is low to the customer. Stated differently, because the service charge identified by the table 500 decreases as the wind speed decreases (at a fixed energy price), the service may be planned on the day with the lowest predicted wind speed. However, delaying the maintenance may risk additional damage to the turbine. Thus, the customer may want to minimize the service charge but not delay performing the service task outside of a predefined time window—e.g., the maintenance should be performed within a month. This predefined time window may vary depending on the type of component (e.g., generator, power converter, blade, etc.) requiring maintenance.

Returning to FIG. 4A, at block 450 the service planning engine compares the turbine service priority associated with the component to other service priorities of components scheduled for maintenance. Specifically, the service planning engine may use the service priorities to order or arrange the different maintenance tasks. In one embodiment, the service priority of a particular component is based on a status signal (e.g., an alert) associated with the component. For example, the status signal may indicate the temperature of the component based on the signal level (e.g., a green, orange, or red alert). A component with a red alert may be assigned a higher service priority than a component with a green or orange alert. The plurality of different ways of generating the service priorities are discussed above.

Based on the service priorities, at block 455, the service planning engine arranges a plurality of maintenance tasks in the maintenance schedule. For example, the service planning engine may have already scheduled a maintenance task on the same time slot selected for the component currently being evaluated. Even though the time slot may be long enough to accommodate both maintenance tasks (e.g., inspecting a blade and performing maintenance on the generator), the service planning engine may put one of the tasks first to ensure the higher priority task is finished during that day. Additionally, if the maintenance tasks are mutually exclusive, i.e., cannot be performed during the same time slot, the service planning engine may use the priorities to determine which available time slot to use. Assume, for example, that the service planning engine has identified a plurality of potential time slots using method 400 for a particular maintenance tasks. If a service planning engine previously assigned a mutually exclusive service project to the earliest time slot, the service planning engine may assign the current maintenance task to that time slot if its service priority is higher. The service planning engine may then repeat method 400 for the removed maintenance task to determine a new time slot. However, if the previously schedule maintenance task has a higher priority, the service planning engine may determine if the next identified time slot is free. This evaluation may continue until either an available time slot is found or the current maintenance task replaces a previously scheduled maintenance task with a lower service priority. It may be possible that the method 400 may not identify a suitable time slot for the maintenance task. In this case, the service planning engine may attempt to schedule the maintenance task during the next maintenance cycle or when the service priority of the component changes. For example, the service priority may increase as the contractual window for performing the service shrinks which may cause the service priority of the maintenance task to exceed the priority of one of the already scheduled maintenance tasks.

At block 460, the service planning engine adds the maintenance task to the maintenance schedule at the identified time slot. In one embodiment, the service planning engine may wait to output the maintenance schedule until all the components are scheduled. For example, a user may identify a subset of components to the service planning engine. After the engine finds an available time slot for each of the components in the identified subset (or determines that a suitable time slot is not available), the engine outputs the schedule. In another embodiment, the service planning engine may output the schedule at intervals. For example, the service planning engine may reevaluate each of the maintenance tasks to see if the maintenance schedule should be altered—tasks moved to different days or tasks removed and replaced by higher priority task, etc. As such, the service planning engine may update the maintenance schedule each time the engine receives updated weather conditions, energy prices, or service priorities.

FIG. 4B illustrates a portion of the method 400 that is performed if the service planning engine determines that the maintenance task is non-optimized—e.g., the task is not scheduled to reduce lost revenue—as discussed in block 405 of FIG. 4A. Generally, when deciding to perform non-optimized maintenance, the service planning engine does not consider the predicted energy price (e.g., blocks 425 and 430 of FIG. 4A). Instead, the service planning engine attempts to identify a time to perform the maintenance regardless of the lost revenue.

At block 465, the service planning engine determines whether the turbine is inoperable. For example, a non-optimized maintenance task may be associated with components that have already failed. If, however, the turbine is still functional—i.e., able to generate power—the method 400 progress to block 470 where a more in-depth evaluation may be performed. Specifically, if the component has not yet failed, the service planning engine may compare the probability of failure to one or more predefined thresholds. In one embodiment, the service planning engine uses the signals received from the turbine in a decision tree or in a failure model to determine whether to perform the maintenance task as a schedule task or a non-optimized service task. A more detailed example of evaluating the likelihood of failure is provided below in FIG. 6.

If the probability of failure is less than the threshold (i.e., the risk of failure is below an acceptable level), the service planning engine re-characterizes the non-optimized task as an optimized task and proceeds to block 410 of FIG. 4A. There, the service planning engine schedules the task based on the predicted cost of energy to minimize the lost revenue. However, if the probability of failure exceeds the threshold, the method 400 proceeds to block 475 where the service planning engine determines if the predicted wind speeds is less than a predefined threshold. For example, there may be only certain times that the service technicians will be available to work on the turbine (e.g., the turbine is offshore and crews visit the turbine according to a set schedule). The service planning engine determines if the predicted wind speeds for those time slots are below the threshold. This threshold may be the same as the threshold used in block 410 to ensure the maintenance may be performed safely. Alternatively, the service planning engine may schedule an emergency visit to the wind park to perform maintenance on the turbine. For example, the service contract may stipulate that maintenance is to be carried out immediately if a turbine is offline. In this embodiment, the service planning engine may use the current weather conditions to determine whether the wind speeds permit the service activity. If the current or predicted wind speed exceeds the threshold, the service planning engine may wait to schedule the non-optimize service task until the current wind conditions fall below the threshold or new predicted weather conditions are received.

At block 480, the service planning engine determines whether the required resources are available 480. In one embodiment, the service planning engine may evaluate the same labor and inventory constraints discussed at block 420. If the necessary resources are not available, the method 400 returns to block 475 to schedule a new time to perform the service activities when the resources are available (and the wind speeds are below the threshold). If the resources are available, the method 400 returns to block 445 to calculate the service charge to the wind turbine owner based on the incentive graph. Moreover, the method 400 may use the service priority assigned to the non-optimized service task to arrange the labor schedule. For example, non-optimized service tasks may be assigned a service priority greater than optimized service tasks. If an optimize service task is assigned to the same time slot as the non-optimized service task, the service planning engine may remove the optimized task in favor of the non-optimized task. Moreover, the service planning engine may use the service priority to choose between different non-optimized service tasks. When doing so, the service planning engine may generate the service priorities based on, for example, the type of component or the probability of failure that was generated at block 470. In this manner, the service planning engine is able to generate a maintenance schedule based on at least two types of service activities (optimized and non-optimized).

FIG. 6 illustrates a method 600 of evaluating a probability of failure of a turbine, according to one embodiment described herein. Specifically, method 600 is one example of evaluating a probability of failure for a component in a wind turbine as discussed in block 470 of FIG. 4B. Here, method 600 establishes a decision tree that prioritizes the different alerts that may be monitored. At block 605, the service planning engine determines if the alert (or alerts) that caused the non-optimized service task is associated with a key component in the turbine. In one embodiment, a key component may be a component that, if it fails, causes the wind turbine to cease generating power. In another embodiment, a key component may be a component that does not have a backup or redundant system in the turbine. If the component associated with the service is a key component, the method 600 proceeds to block 610, but if not, the method proceeds to block 615.

At block 610, the service planning engine evaluates the duration of the alert associated with the key component. That is, the turbine may continue to issue the alert for as long as the turbine detects the component behaves abnormally. For example, if the alert has been red for over a minute (i.e., the predefined threshold), the service planning engine proceeds to block 475 of FIG. 4B and schedules the task without consider the future energy costs. In other embodiments, the service planning engine may have multiple thresholds that respectively correspond to different levels of alert. For example, the service planning engine may have a one minute duration threshold for high alerts (red alerts) but a three minute threshold for medium alerts (orange alerts). So long as the alert exceeds one of the thresholds, the service task is tasked as shown in FIG. 4B.

If the alert (or alerts) is not associated with a key component, at block 615, the service planning engine may evaluate the frequency of the alert—i.e., how often the alert is received. For example, the service planning engine may maintain an alert history that includes a record of each time the alert signal is activated. Thus, even if the duration of the alert (i.e., the abnormal behavior) is short, the service planning engine may still schedule a non-optimized service task based on the number of time the alert is activated. For example, if the turbine issues a red alert five times over a time period of five minutes, the method 600 may proceed to block 475. Additionally, the service planning engine may include multiple thresholds that each correspond to different types of alerts. If the alert is orange, the service planning engine may require that ten alerts be received in a five minute period. If one of the thresholds is exceeded, the method 600 proceeds to block 475 of FIG. 4B, but if not, the method 600 proceeds to block 410 of FIG. 4A where the service activity is treated as an optimized service task.

The factors used in method 600 may be the same factors that are used to choose between optimized and non-optimized service tasks in block 405 in FIG. 4A. However, method 600 prioritizes the different factors to determine the likelihood the component will fail while the query at block 405 may be satisfied as long as any of the thresholds are satisfied. Moreover, the thresholds used in query 405 may be different than the thresholds used in method 600. Although method 600 illustrates one particular example of arranging a decision tree to reflect the probability a component will fail, this disclosure is not limited to such.

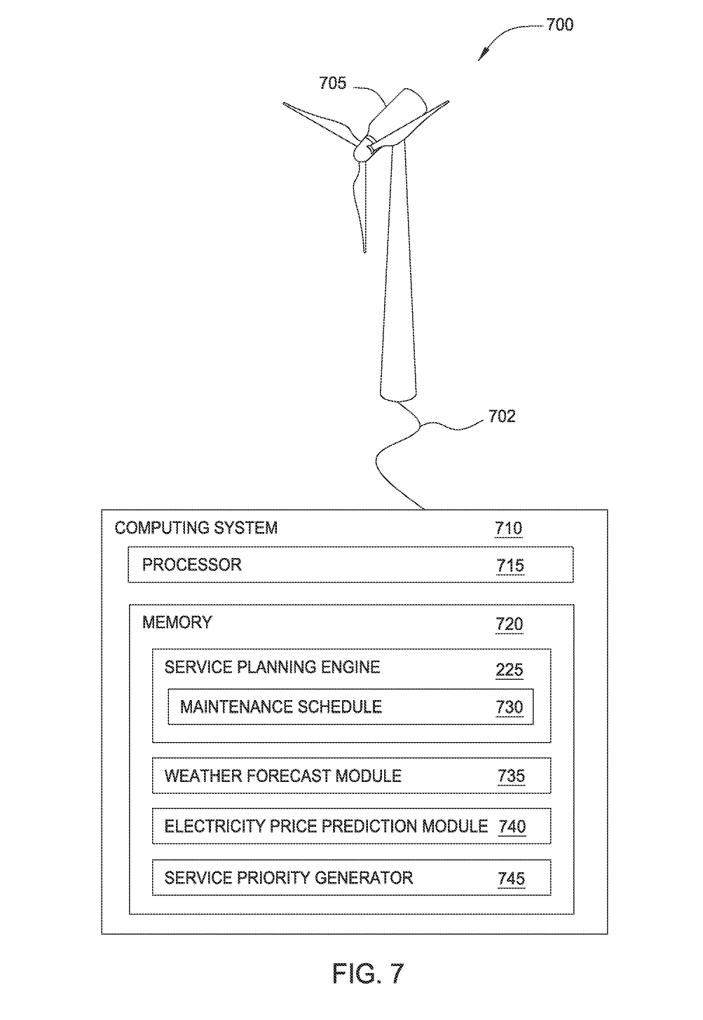

FIG. 7 illustrates a computing system 710 for generating a maintenance schedule, according to one embodiment described herein. The system 700 includes a wind turbine 705 and a computing system 710 communicatively coupled to the wind turbine 705 via communication link 702 which represents a wireless or wired communication method. In one embodiment, the communication link 702 permits the different status signals generated by the turbine 705 to be shared with the computing system 710. For example, the computing system 710 may be part of a supervisory control and data acquisition (SCADA) system.

The computing system includes a processor 715 and memory 720. The processor 715 represents any type of processing element capable of performing the functions detailed herein. For example, the processor 715 may represent multiple processors or multi-core processors. The memory 720 may be implemented by volatile or non-volatile memory such as random access memory (e.g., DRAM or Flash) or cache. Memory 720 may also include storage elements such as a hard disk drive, solid state device (SSD), flash memory storage drive, or even memory elements external to the computing system 710.

The memory includes a service planning engine 225, weather forecast module 735, electricity price prediction module 740, and a service priority generator 745. The service planning engine 225 may be a software application that uses method 400 in FIGS. 4A-4B to schedule maintenance tasks on the components in the turbine 705. Although system 700 illustrates only one turbine, in one embodiment, the service planning engine 225 may be coupled to multiple turbines in a wind park. Based on the embodiments discussed above, the service planning engine 225 generates a maintenance schedule 730 that includes one or more maintenance tasks associated with respective components or systems in a single turbine or in a plurality of turbines.

The weather forecast module 735 may be a software tool that receives a predefined time period from the service planning engine 225 and use different data sources to predict the future weather conditions (e.g., the wind speed) for that time period. In one embodiment, the weather forecast module 735 may predict weather conditions using a weather forecast and historical data. The weather forecast may include temperature, barometric pressure, pressure systems, movement of the jet stream, and any other atmospheric condition that may affect the amount of power the turbines can generate. The weather forecast data may come from a public data source (e.g., a government service) or from measuring different weather sensors associated with the wind farm whose values are then used to predict the weather conditions. The historical data may include the previously measured weather conditions as well as previous wind power outputs of the wind farm. In one example, historical data may include an average wind speed for a particular calendar day. Moreover, the historical data may be used to interpret the weather forecast data. For example, the historical data may indicate that when a low pressure front moves through, the wind speed averages 8 meters/second. Thus, if the weather forecast data indicates a low pressure front will pass over the wind farm, the expected wind speed will be around 8 m/s. The service planning engine 225 may use the predicted wind speeds to determine whether maintenance can be performed safely as well as calculate a service charge for performing the maintenance.

The electricity price prediction module 740 may be a software tool that generates the predicted cost per unit of energy for the utility grid coupled to the turbine 705 for a predefined time period. For example, the module 740 may generates the predicted price based on the factors illustrated in FIG. 3A. Based on the predicted cost of energy, the service planning engine 225 may determine whether to perform maintenance which may take the turbine offline, thereby costing the turbine owner lost revenue.

The service priority generator 745 may be a software tool that generates a priority score for the turbine 705 or each monitored component in the turbine 705. The generator 745 may monitor use the component's type, the component's status (whether the component has failed), or the frequency or duration of the abnormal behavior of the component or turbine to generate the score. Based on the score, the service planning engine 225 may select the order in which to perform service activities. That is, the engine 225 may use the priority score to choose between the different components that require service.

Although the service planning engine 225, weather forecast module 735, electricity price prediction module 735, and service priority generator 745 are shown as applications in memory 720, these tools may be implement as either hardware modules or a combination of hardware and software. Moreover, the different tools may be distributed onto different computing systems. For example, the weather forecast module 735 may be located on a different computing system and the predicted wind speeds may be transmitted to the computing system 710.

Moreover, the previous embodiments described various techniques for scheduling maintenance tasks in a wind power plant—e.g., a wind farm. However, the same techniques may be used (or modified) with other types of power plants as well. That is, the predicted weather conditions and energy price may also be used to determine whether to perform maintenance that will reduce the amount of power generated by the plant. Thus, one of ordinary skill in the art will recognize how the techniques above may be modified to apply to different types of power plants.

In the previous discussion, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### CONCLUSION

Determining when to perform preventative maintenance is an important consideration for maximizing the revenue of a wind turbine. Preventative maintenance may be scheduled to minimize the cost of repair and the lost power production. For example, the owner of the wind farm may sign a service contract that specifies a particular schedule or window for performing service on the components in the wind turbines. However, performing maintenance on certain components in a wind turbine may require disconnecting the turbine from the grid (i.e., taking the turbine offline), thereby reducing the amount of revenue produced by the farm. Because the revenue generated by the wind farm is dependent on both the wind speed and the energy price (i.e., the cost of a unit of energy), a service planning engine may generate an incentive table to aid in scheduling maintenance tasks. Specifically, the incentive table enables the service planning engine to perform maintenance such that the lost revenue is minimized.

To generate the incentive tables and schedule the maintenance tasks, the service planning engine may predict the future wind speed at the wind farm as well as the future price of energy of the utility grid coupled to the wind turbines. Based on the predicted values, the service planning engine identifies times to perform maintenance when lost revenue is minimized. Furthermore, the service planning engine may calculate a service priority associated with the turbine to determine when to perform service. The service priority may be based on a status signal associated with the component to be serviced or the time window stipulated in the service contract for performing the maintenance. In one embodiment, the service planning engine also considers resource constraints such as labor costs (e.g., work schedules, overtime costs, availability of technicians with certain skills, availability of components, shipping costs, and the like).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method of scheduling a maintenance task in a power plant, comprising:
generating, based on one or more processors, a predicted cost of electrical power associated with a utility grid coupled to the power plant for a time window;
identifying a time slot within the time window for performing the maintenance task;
upon determining that the predicted cost during the identified time slot is expected to be below a cost threshold, scheduling the maintenance task in a maintenance schedule; and
upon determining that the predicted cost during the identified time slot is expected to be above the cost threshold, determining whether the maintenance task can be postponed based on a service deadline associated with the maintenance task.

2. The method of claim 1, further comprising:
comparing an accuracy score for a range of predicted cost values below the cost threshold to a predefined accuracy threshold, the accuracy score representing the likelihood that an actual cost of electrical power during the identified time slot will fall within the range of predicted cost values;
upon determining the accuracy score satisfies the predefined accuracy threshold, scheduling the maintenance task in the maintenance schedule.

3. The method of claim 1, further comprising:
generating predicted weather conditions at the power plant for the time window;
upon determining that the predicted weather conditions during the time slot are safe for performing the maintenance task, scheduling the maintenance task in the maintenance schedule.

4. The method of claim 1, wherein scheduling the maintenance task in the maintenance schedule comprises:
generating a priority score associated with the maintenance task, the priority score based on at least one of a type of component associated with the maintenance task, a status signal associated with the maintenance task, and a period of time remaining to perform the maintenance task by the service deadline; and
determining an ordering of a plurality of maintenance tasks by comparing the priority score associated with the maintenance task to respective priority scores of the plurality of maintenance tasks.

5. The method of claim 4, further comprising:
upon determining another maintenance task is already scheduled to be performed in the time slot, comparing the priority score of the maintenance task to a priority score of the another maintenance task.

6. The method of claim 1, wherein identifying the time slot for performing the maintenance task comprises:
determining whether a resource necessary for performing the maintenance task is available during the time slot, the resource is one of an availability of a technician that performs the maintenance task or an availability of spare parts used in the maintenance task.

7. The method of claim 1, further comprising, before determining whether the predicted cost is expected to be below the cost threshold:
characterizing the maintenance task as one of an optimized service task and a non-optimized service task based on a severity level derived from one or more status signals associated with the maintenance task that are received from the power plant, wherein the optimized service task is scheduled using the predicted cost and the non-optimized service task is not scheduled based on the predicted cost.

8. The method of claim 1, wherein the power plant is a wind turbine and the service deadline is defined in a service contract associated with performing maintenance on the wind turbine.

9. A system, comprising:
a computer processor; and
a memory containing a program that, when executed on the computer processor, performs an operation for scheduling maintenance tasks in a power plant, comprising:
generating a predicted cost of electrical power associated with a utility grid coupled to the power plant for a time window;
identifying a time slot within the time window for performing the maintenance task;
upon determining that the predicted cost during the identified time slot is expected to be below a cost threshold, scheduling the maintenance task in a maintenance schedule; and
upon determining that the predicted cost during the identified time slot is expected to be above the cost threshold, determining whether the maintenance task can be postponed based on a service deadline associated with the maintenance task.

10. The system of claim 9, the operation further comprising:
comparing an accuracy score for a range of predicted cost values below the cost threshold to a predefined accuracy threshold, the accuracy score representing the likelihood that an actual cost of electrical power during the identified time slot will fall within the range of predicted cost values;
upon determining the accuracy score satisfies the predefined accuracy threshold, scheduling the maintenance task in the maintenance schedule.

11. The system of claim 9, the operation further comprising:
generating predicted weather conditions at the power plant for the time window;
upon determining that the predicted weather conditions during the time slot are safe for performing the maintenance task, scheduling the maintenance task in the maintenance schedule.

12. The system of claim 9, wherein scheduling the maintenance task in the maintenance schedule comprises:
generating a priority score associated with the maintenance task, the priority score based on at least one of a type of component associated with the maintenance task, a status signal associated with the maintenance task, and a period of time remaining to perform the maintenance task by the service deadline; and
determining an ordering of a plurality of maintenance tasks by comparing the priority score associated with the maintenance task to respective priority scores of the plurality of maintenance tasks.

13. The system of claim 12, the operation further comprising:
upon determining another maintenance task is already scheduled to be performed in the time slot, comparing the priority score of the maintenance task to a priority score of the another maintenance task.

14. The system of claim 9, wherein the power plant is a wind turbine and the service deadline is defined in a service contract associated with performing maintenance on the wind turbine.

15. A computer program product for scheduling maintenance tasks in a power plant, the computer program product comprising:
a computer-readable storage medium having computer-readable program code embodied therewith, the computer-readable program code comprising computer-readable program code configured to:
generate a predicted cost of electrical power associated with a utility grid coupled to the power plant for a time window;
identify a time slot within the time window for performing the maintenance task;
upon determining that the predicted cost during the identified time slot is expected to be below a cost threshold, schedule the maintenance task in a maintenance schedule; and
upon determining that the predicted cost during the identified time slot is expected to be above the cost threshold, determine whether the maintenance task can be postponed based on a service deadline associated with the maintenance task.

16. The computer program product of claim 15, further comprising computer-readable program code configured to:
compare an accuracy score for a range of predicted cost values below the cost threshold to a predefined accuracy threshold, the accuracy score representing the likelihood that an actual cost of electrical power during the identified time slot will fall within the range of predicted cost values;
upon determining the accuracy score satisfies the predefined accuracy threshold, schedule the maintenance task in the maintenance schedule.

17. The computer program product of claim 15, further comprising computer-readable program code configured to:
generate predicted weather conditions at the power plant for the time window;
upon determining that the predicted weather conditions during the time slot are safe for performing the maintenance task, scheduling the maintenance task in the maintenance schedule.

18. The computer program product of claim 15, wherein scheduling the maintenance task in the maintenance schedule comprises computer-readable program code configured to:
generate a priority score associated with the maintenance task, the priority score based on at least one of a type of component associated with the maintenance task, a status signal associated with the maintenance task, and a period of time remaining to perform the maintenance task by the service deadline; and
determine an ordering of a plurality of maintenance tasks by comparing the priority score associated with the maintenance task to respective priority scores of the plurality of maintenance tasks.

19. The computer program product of claim 18, further comprising computer-readable program code configured to:
upon determining another maintenance task is already scheduled to be performed in the time slot, compare the priority score of the maintenance task to a priority score of the another maintenance task.

20. The computer program product of claim 15, wherein the power plant is a wind turbine and the service deadline is defined in a service contract associated with performing maintenance on the wind turbine.
